(19) United States
(12) Patent Application Publication
(10) Pub. No.: US 2018/0013364 A1
(43) Pub. Date: Jan. 11, 2018

(54) WIND POWER GENERATING EQUIPMENT, OPERATION METHOD THEREOF, AND WIND FARM

(71) Applicant: HITACHI, LTD., Tokyo (JP)

(72) Inventors: Yuta ITOH, Tokyo (JP); Kiyoshi SAKAMOTO, Tokyo (JP); Hikaru MEGURO, Tokyo (JP); Tomohiro FUJII, Tokyo (JP)

(73) Assignee: HITACHI, LTD., Tokyo (JP)

(21) Appl. No.: 15/638,917

(22) Filed: Jun. 30, 2017

(30) Foreign Application Priority Data
Jul. 5, 2016 (JP) 2016-133235

(51) Int. Cl. H02P 9/10; F03D 7/02

(52) U.S. Cl. CPC H02P 9/102; F03D 7/0272; F03D 9/25; H02P 2101/15; F05B 2270/1071; H02P 9/10

(57) ABSTRACT

Wind power generating equipment includes: a generator that is driven by a blade which rotates by receiving the wind; a power converter that converts an electric output of the generator such that the output is interconnected with an electric power system; a power converter controller that controls the power converter; and a wind turbine control board that transmits, to the power converter controller, an active power command value that is used as a command value of the electric output which is transmitted from the power converter. The power converter controller controls the output of the power converter in response to an active power command value, depending on a reduction amount of a system voltage when instantaneous reduction occurs in the system voltage interconnected with the wind power generating equipment. This permits stable operation of the wind power generating system when instantaneous voltage reduction occurs such as during a system abnormality.

### TECHNICAL FIELD

The present invention relates to wind power generating equipment, operation method of the wind power generating equipment, and a wind farm, particularly, to wind power generating equipment, operation method thereof, and a wind farm which are suitable during voltage reduction and power return of an interconnected system.

### BACKGROUND ART

Wind power generating equipment is an environment-friendly power generation method without emission of dioxide and thus, recently, the wind power generating equipment has been introduced. However, when a system voltage is instantaneously reduced due to a lightning strike or the like, a phenomenon of collective cutoff of the wind power generating equipment from a system occurred in the past. Therefore, it is mandatory for the wind power generating equipment to have a fault ride through (FRT) function of continuing an operation even when instantaneous voltage reduction occurs during an occurrence of system abnormality.

PTL 1 discloses, as a control method employed when system voltage reduction occurs, a wind power generating power conversion system that controls power consumed by a chopper and a resistor in a power conversion system and torque of a generator, by using output power and a rotation speed of the generator, a frequency of FRT, a torque command value as an output from a generator control system as a high-order system of the power conversion system.

### CITATION LIST

### Patent Literature

PTL 1: JP-A-2015-023616

### SUMMARY OF INVENTION

### Technical Problem

However, a technology disclosed in PTL 1 has a problem in that, since the power conversion system operates by receiving the torque command value from the generator control system as the high-order system even when instantaneous reduction occurs in the system voltage, delay occurs in data communication, and thus a response to an abrupt transient phenomenon such as the instantaneous voltage reduction is delayed. The instantaneous voltage reduction during an occurrence of system abnormality is a phenomenon of the order of several milliseconds. Therefore, in a case where there is no immediate response due to long control delay, a phenomenon of causing damage to smoothing capacitor due to an increase in a DC voltage inside the power conversion system or causing a significant increase occurs in rotation speed of the wind power generator, and thus the wind power generating equipment stops operating.

An object of the invention is to provide wind power generating equipment, an operation method of the wind power generating equipment, and a wind farm, which are capable of reducing control delay due to data communication between a power conversion system and a wind turbine control board as a high-order system thereof and stably continuing an operation of a wind power generating system when instantaneous voltage reduction occurs during an occurrence of system abnormality.

### Solution to Problem

In consideration of such an above circumstance, according to the invention, there is provided wind power generating equipment including: a generator that is driven by a blade which rotates by receiving the wind; a power converter that converts an electric output of the generator such that the output is interconnected with an electric power system; a power converter controller that controls the power converter; and a wind turbine control board that transmits, to the power converter controller, an active power command value that is used as a command value of the electric output which is transmitted from the power converter. The power converter controller controls an electric output of the power converter in response to an active power command value depending on a reduction amount of a system voltage when instantaneous reduction occurs in the system voltage interconnected with the wind power generating equipment.

In addition, according to the invention, there is provided an operation method of wind power generating equipment that includes a generator that is driven by a blade which rotates by receiving the wind and a power converter that converts an electric output of the generator such that the output is interconnected with an electric power system, the method including: controlling an electric output of the power converter in response to an active power command value depending on a reduction amount of the system voltage when instantaneous reduction occurs in a system voltage interconnected with the wind power generating equipment.

In addition, according to the invention, there is provided an operation method of wind power generating equipment that includes a generator that is driven by a blade which rotates by receiving the wind and a power converter that converts an electric output of the generator such that the output is interconnected with an electric power system, the method including: controlling the power converter by using an active power command value that is transmitted as a command value of the electric output of the power converter and corresponds to a machine input from the generator during a normal operation, the active power command value containing a variation reducing component that reduces variations in a rotation speed of the generator; controlling an electric output of the power converter in response to an active power command value depending on a reduction amount of a system voltage when instantaneous reduction in the system voltage interconnected with the wind power generating equipment occurs; and transmitting, to the power converter controller, the active power command value that increases with the elapse of time when the system voltage returns after the instantaneous reduction in the system voltage interconnected with the wind power generating equipment, the active power command value containing a variation reducing component that reduces variations in a rotation speed of the generator.

In addition, according to the invention, there is provided a wind farm including: a plurality of units of the wind power generating equipment. The wind firm includes a plurality of generators that are driven by a blade which rotates by receiving the wind and one or a plurality of power converters that convert an electric output of the generator such that the output is interconnected with an electric power system.

### Advantageous Effects of Invention

According to the invention, even when instantaneous voltage reduction occurs during an occurrence of system abnormality, it is possible to control the power of the wind power generating equipment in a highly responsive manner, and it is possible to stably continue an operation of a wind power generating system.

### BRIEF DESCRIPTION OF DRAWINGS

FIG. 1 is a diagram illustrating a configuration of wind power generating equipment according to Example 1 of the invention.

FIG. 2 is a diagram illustrating a level of an active power command value of the wind power generating equipment before and after an occurrence of system voltage reduction.

FIG. 3 is a diagram illustrating a circuit configuration of a wind turbine control board 15.

FIG. 4 is a diagram illustrating a configuration of wind power generating equipment according to Example 2 of the invention.

### DESCRIPTION OF EMBODIMENTS

Hereinafter, Examples of the invention will be described with reference to the figures.

### EXAMPLE 1

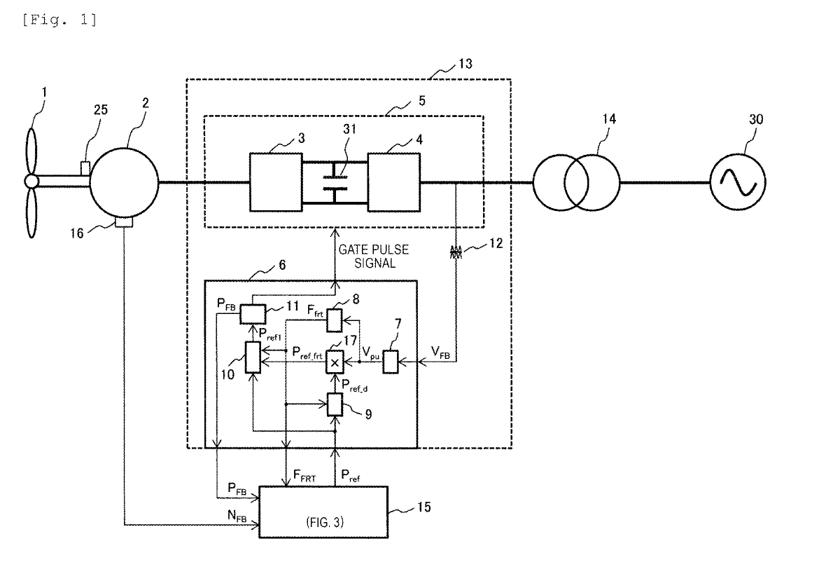

FIG. 1 is a diagram illustrating a configuration of wind power generating equipment according to Example 1 of the invention. In FIG. 1, a main body of the wind power generating equipment is configured to include a blade 1, a generator 2, and a power conversion system 13. In addition, an output of the generator 2 is interconnected from the power conversion system 13 via a step-up transformer 14 to a power system 30.

The power conversion system 13 is configured to include a power converter 5 and a power converter controller 6. The power converter 5 is configured to include a DC capacitor 31 disposed between a generator-side power converter 3 and a system-side power converter 4. The generator-side power converter 3 converts AC power of the generator 2 as a synchronous generator into DC power and the system-side power converter 4 converts DC power of the generator-side power converter 3 into AC power.

The generator-side power converter 3 and the system-side power converter 4 are subjected to striking control in response to a gate pulse signal transmitted from the power converter controller 6. In addition, an active power command value P_{ref} is transmitted to the power converter controller 6 from a wind turbine control board 15 as a high-order device thereof, and the power converter controller 6 determines the gate pulse signal depending on the active power command value P_{ref}. In FIG. 1, reference sign 12 represents a system voltage detector in the power converter 5, reference sign 16 represents a rotation speed detector of the generator, and reference sign 25 represents a high-speed shaft brake.

In the wind power generating equipment configured as described above, the wind turbine control board 15 obtains a rotation speed N_{FB} from the rotation speed detector 16 of the generator 2, generates the active power command value and transmits the value to the power converter controller 6. Here, the active power command value P_{ref} is a value that is variable depending on the rotation speed N_{FB}; however, in the invention, since a focus on an attention is paid to an operation in a short time from reduction of the voltage due to an occurrence of a problem in the power system 30 to returning of the voltage with opening of a shut-off switch, the active power command value P_{ref} within this period may be considered to be constant in a relationship with the rotation speed N_{FB}. In the invention, as will be described below, the power converter controller 6 is controlled through an intentional change of the active power command value P_{ref} when the voltage reduction occurs by using signals F_{FRT} and P_{FB} generated by the power converter controller 6.

Next, an operation of the power converter controller 6 will be described. First, the power converter controller 6 detects and inputs a system voltage V_{FB} in the power conversion system 13 by the system voltage detector 12. The system voltage V_{FB} is output as a normalized value Vₚᵤ with a primary-side voltage of the step-up transformer 14 as a reference in a detection-voltage normalizing unit 7 in the power converter controller 6. Subsequently, a voltage-reduction-state determining unit 8 checks whether the normalized value Vₚᵤ is equal to or smaller than a predetermined threshold value, and outputs a signal F_{frt} that indicates a system voltage reduction state when the value is equal to or smaller than a predetermined threshold value. In this manner, the system-voltage-reduction state signal F_{frt} is “0” during a normal operation, and the system-voltage-reduction state signal F_{frt} is “1” when the system voltage reduction occurs.

The power converter controller 6 receives the active power command value P_{ref} transmitted from the wind turbine control board 15 and transmits the value as a power command value during the normal generation to an active-power calculating unit 10. At the same time, the active power command value P_{ref} is also input to an active-power-command-value storage unit 9, the active-power-command-value storage unit 9 saves and stores the active power command value P_{ref} and outputs an active power command value P_{ref} obtained before one sampling. The active-power-command-value storage unit 9 repeats such operations in a case where the system-voltage-reduction state signal F_{frt} is “0: when the system voltage is normal” and the active power command value P_{ref} is updated. However, when the system-voltage-reduction state signal F_{frt} is “1: the voltage reduction state”, the active-power-command-value storage unit stops updating the active power command value P_{ref} and stores a final value obtained in the case where the system-voltage-reduction state signal F_{frt} is “0: when the system voltage is normal”.

A multiplier 17 computes and outputs, as a product of the normalized value Vₚᵤ and the active power command value P_{ref}_{_}_{d} before one sampling, a value P_{ref frt} (=P_{ref d}×Vₚᵤ) depending on a reduction amount of the system voltage, as the active power command value when the system voltage reduction occurs. For example, in a case where a voltage is 0.3 at the time of sampling immediately after the system voltage reduction with respect to a voltage at the time of the sampling before the system voltage reduction, Vₚᵤ is 0.3 and the value P_{ref}_{_}_{frt} depending on the reduction amount of the system voltage is a value obtained by multiplying P_{ref d} by 0.3.

The active-power-command-value calculating unit 10 determines an active power command value P_{ref1} in response to the system-voltage-reduction state signal F_{frt}. In the case where the system-voltage-reduction state signal F_{frt} is “0: when the system voltage is normal”, P_{ref} is output. In addition, in the case where the system-voltage-reduction state signal F_{frt} is “1: the voltage reduction state”, P_{ref}_{_}_{frt} is output.

A power/current control unit 11 calculates a gate pulse signal by using the active power command value output by active-power-command-value calculating unit 10 and a detected current value I_{FB} and a detected voltage value V_{FB} which are detected by the generator-side power converter 3 and the system-side power converter 4 which are not illustrated, respectively, and drives the power converters of the generator-side power converter 3 and the system-side power converter 4. At the same time, the power/current control unit 11 calculates an active power detection value P_{FB} by using the detected current value I_{FB} and the detected voltage value V_{FB} and transmits the value to the wind turbine control board 15.

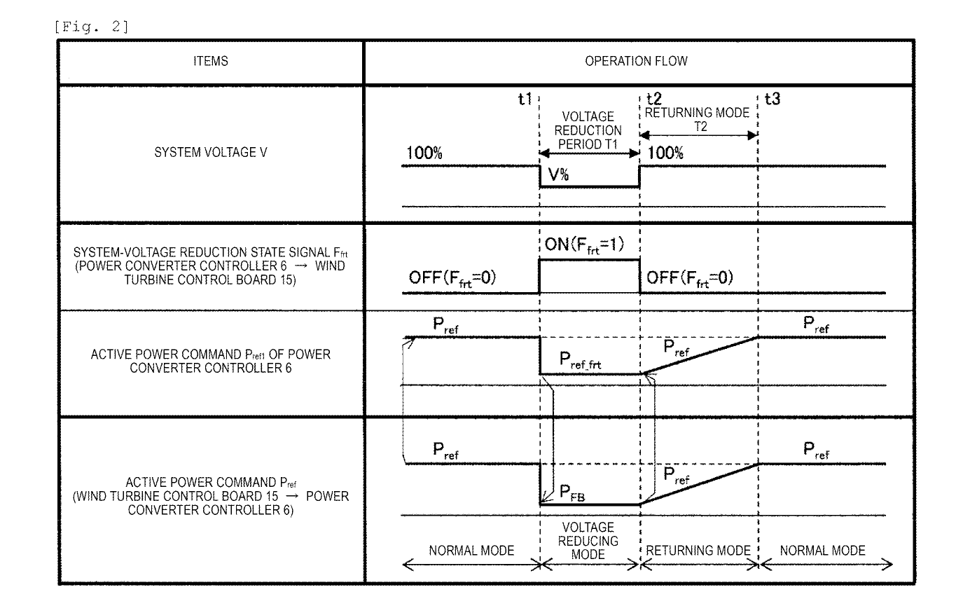

FIG. 2 illustrates temporal variations in the active power command value before and after the voltage reduction which is determined by the power converter controller 6. FIG. 2 illustrates a system voltage V, the system-voltage-reduction state signal F_{frt}, the active power command value P_{ref1} of the power converter controller 6, and the active power command value P_{ref} transmitted from the power converter controller 6, in this order from above.

In such a case, the system voltage V is 100% during the normal operation, the system voltage is instantaneously reduced due to system abnormality at a time point t1, and then the voltage returns to 100% of the voltage as a result of removal of a problem with the opening of the shut-off switch at a time point t2 after a voltage reduction period T1. At this time, the system-voltage-reduction state signal F_{frt} transmitted from the voltage-reduction-state determining unit 8 in FIG. 1 is “1” during the voltage reduction period T1 between the time points t1 and t2, and time zones before and after the period are A state in which the system-voltage-reduction state signal F_{frt} transmitted from the voltage-reduction-state determining unit 8 is ON (F_{frt}=1) is set to a voltage reducing mode and T1 represents this period.

In this voltage reduction state, the active power command value P_{ref1} transmitted from the active-power-command-value calculating unit 10 is P_{ref}_{_}_{frt} generated in the multiplier 17. In other words, an active power command value obtained by reflecting the state of the voltage reduction is set. For example, when the voltage is reduced to 30% of the normal operation, P_{ref}_{_}_{frt} corresponding to 30% thereof, which is transmitted from the multiplier 17, is transmitted to the power converter 5 via the power/current control unit 11, as the active power command value P_{ref1} transmitted from the active-power-command-value calculating unit 10. In this manner, the power converter controller 6 controls the power with the active power command value P_{ref}_{_}_{frt} independently computed in the power converter controller 6 without using the active power command value P_{ref} from the wind turbine control board 15. The active power value P_{FB} controlled by using the active power command value P_{ref}_{_}_{frt} is transmitted to the wind turbine control board 15, and the wind turbine control board 15 uses the P_{FB} as the active power command value as described by active power command value P_{ref}.

According to such a configuration described above, the power conversion system 13 computes the active power command value depending on the reduction amount of the system voltage independently in the power converter controller 6 in the wind power generating equipment, without using the active power command value from the wind turbine control board 15 as a high-order system of the power conversion system 13, thus is capable of controlling the power of the wind power generating equipment in a highly responsive manner by controlling the power depending on the computed active power command value, and is capable of stably continuing an operation of a wind power generating system when system abnormality occurs.

Then, after the returning of the system voltage V at the time point t2, the system-voltage-reduction state signal F_{frt} is OFF (F_{frt}=0) as illustrated in FIG. 2, the power conversion system 5 controls the power, depending on the value of the active power command value P_{ref} transmitted from the wind turbine control board 15.

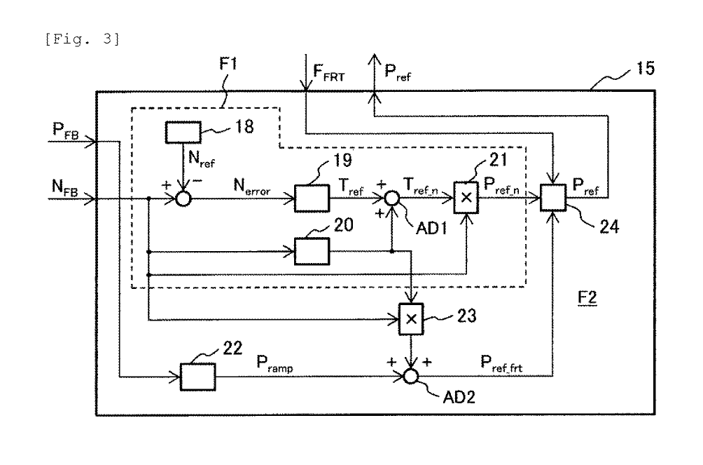

However, immediately after the returning of the system voltage, since an active voltage of the wind power generator 2 decreases to a value depending on the reduction amount of the voltage, a state (returning mode) of returning to the active voltage occurs. An operation of the returning mode is described with reference to FIG. 3 illustrating a detailed configuration of the wind turbine control board 15 that outputs the power command value P_{ref} controlled by the power conversion system. In FIG. 2, a period of the returning mode is illustrated as a period T2 from the time point t2 to t3.

FIG. 3 is a diagram illustrating a circuit configuration of the wind turbine control board 15. To be broad, functions of the wind turbine control board 15 illustrated in FIG. 3 largely include a function F1 of determining the active power command value P_{ref} during the normal operation, and a function F2 of determining the active power command value P_{ref} in the returning mode.

First, the function F1 of determining the active power command value P_{ref} during the normal operation is described. The wind turbine control board 15 receives the rotation speed N_{FB} of the generator 2 which is detected by the rotation speed detector 16 and calculates deviation Nₑᵣᵣₒᵣ of N_{ref} that is output from the rotation speed command computing device 18. API controller 19 computes a reference torque command value T_{ref} by using the calculated deviation Nₑᵣᵣₒᵣ. In addition, a vibration component is derived from the rotation speed N_{FB} of the generator 2, a drive-train-vibration reducing controller 20, which calculates a torque command value that reduces the vibration component, computes a driver-train-vibration reducing torque command value, adds the computed value to the reference torque command value T_{ref} obtained by the PI controller 19 in an adder AD1, and calculates a torque command value T_{ref}_{_}ₙ during the normal operation. The multiplier 21 multiplies the torque command value T_{ref n} during the normal operation and N_{FB}, and calculates the active power command value P_{ref} during a normal operation.

To describe very briefly, the function F1 of determining the active power command value P_{ref} during the normal operation is to determine a target value of an electric output corresponding to a machine input to a wind turbine. Thus, at this time, a vibration reducing component of a drive train can be described as a signal added to the target value of the electric output.

By comparison, the function F2 of determining the active power command value P_{ref} in the returning mode is the rest part other than the function F1 of determining the active power command value P_{ref} during the normal operation from the functions of the wind turbine control board 15.

By the function F2 of determining the active power command value P_{ref} in the returning mode, a returning-mode active-power-command-value computing unit 22 stores the active power command value P_{FB} received from the power converter controller 6 when the system voltage reduction (F_{frt}=1) occurs. Next, the returning-mode active-power-command-value computing unit 22 outputs an active power command value Pᵣₐₘₚ increasing at any rate in a ramp shape with P_{FB} after the returning of the system voltage (F_{frt}=0) as an initial value.

On the other hand, a multiplier 23 multiplies the driver-train-vibration reducing torque command value computed by the drive-train-vibration reducing controller 20 and the generator rotation speed N_{FB}. The active power command value Pᵣₐₘₚ increasing in the ramp shape and the multiplied value by the multiplier 23 are added in an adder AD2, and the active power command value P_{ref frt} is calculated in the returning mode.

In addition, an active-power-command calculating unit 24 performs a change in a value of a signal of the system-voltage-reduction state signal Fₜᵣₜ and comparison of magnitudes of P_{ref}_{_}ₙ and P_{ref}_{_}_{frt} calculates the active power command value P_{ref}, outputs P_{ref}_{_}ₙ as the active power command value P_{ref} during the normal operation, and outputs P_{ref}_{_}_{frt} as the active power command value P_{ref} in the returning mode. Since P_{ref}_{_}_{frt} is the active power command value obtained by adding a value obtained by multiplying the driver-train-vibration reducing torque command value and the generator rotation speed N_{FB} in the multiplier 23, it is possible to reduce variations in the generator rotation speed in the returning mode, similarly to a normal mode.

In such a configuration according to the invention, after the returning from the voltage reduction state, the power is controlled, depending on an active power command value incorporated in drive train vibration reducing control, and thereby it is possible to reduce the variations in the generator rotation speed, and it is possible to stably continue the operation of the wind power generating system even after the system returning.

In addition, according to the invention, even in a case of either of the voltage reduction mode during the system abnormality or the returning mode, it is possible to reduce the variations in the generator rotation speed with the power control in the power converter controller 6 and the drive-train-vibration reducing control by the wind turbine control board 15, without an operation of the high-speed shaft brake 25 illustrated in FIG. 1.

Since the high-speed shaft brake 25 operates after receiving an operation command signal from the wind turbine control board 15, mechanical time-constant delay (hundreds of ms) occurs. When the operation is performed during a phenomenon in which instantaneous voltage reduction obtained when the system abnormality occurs is at about minimum 100 ms, the variations in the generator rotation speed is reduced through power control, the generator rotation speed has a value smaller than a predetermined value, and unstable variations in the rotation speed occurs.

Therefore, in the configuration of this Example in which the high-speed shaft brake does not operate when the system voltage reduction occurs and after the returning, it is possible to reduce the variations in the generator rotation speed when the system voltage reduction occurs and after the returning, and it is possible to stably continue the operation of the wind power generating system even after the returning of the system.

### EXAMPLE 2

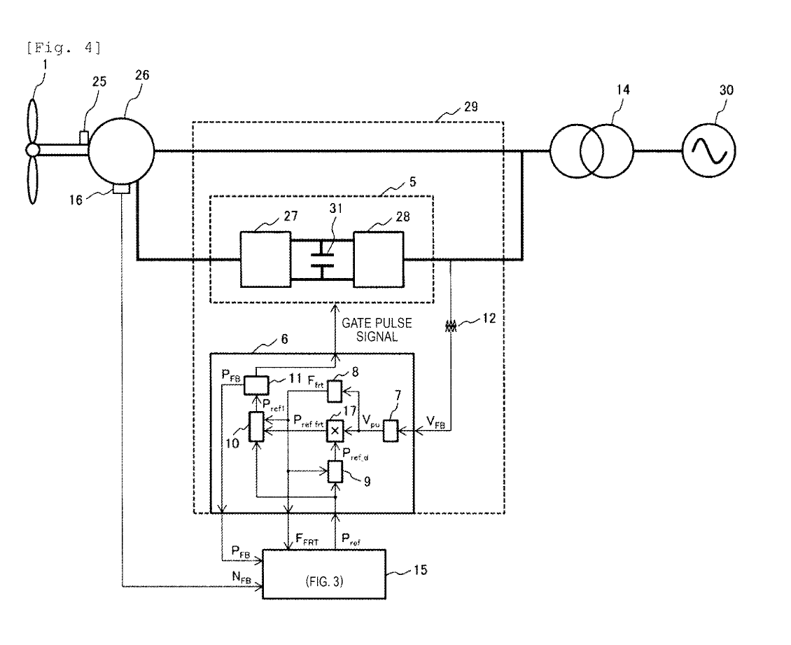

Next, differences of Example 2 from Example 1 of the invention will be mainly described. In Example 1, the generator 2 is the synchronous generator, and the power conversion system 5 has a configuration of a full converter; however, the generator 2 is a secondary excitation winding induction generator, and the power conversion system 5 is a secondary excitation type power conversion system as illustrated in FIG. 4 in Example 2.

In Example 2, in order to control a frequency and a magnitude of an excitation current applied to a rotor of the secondary excitation winding induction generator 26, the power conversion system 5 is replaced with a secondary excitation type power conversion system 29 and is configured to include a rotor-side power converter 27 that converts AC power of a rotor into DC power and a system-side power converter 28 that converts DC power of the rotor-side power converter into AC power. Also in Example 2, in the power converter 5 similar to Example 1, the gate pulse signal is output from the power converter controller 6, and the rotor-side power converter 27 and the system-side power converter 28 are driven.

As described above, in Example 1, in the configuration in which the generator is the synchronous generator, and the power conversion system is a full converter, effects of the invention are achieved; however, as described in Example 2, in the configuration in which the generator is a secondary excitation winding induction generator, and the power conversion system is a secondary excitation type power conversion system, it is also possible to achieve the same effects as those in Example 1.

As described above, the wind power generating equipment described in Examples 1 and 2 forms a so-called wind farm in which a plurality of units of equipment are installed in the same site in many cases. In this case, an aspect of installation of the power conversion system for each generator, individually, and an aspect of common installation of the power conversion system with respect to a plurality of generators are considered; however, the invention is applicable to any case.

### REFERENCE SIGNS LIST

1: blade

2: generator

3: generator-side power converter

4: system-side power converter

5: power converter

6: power converter controller

7: detection-voltage normalizing unit

8: voltage-reduction-state determining unit

9: active-power-command-value storage unit

10: active-power-command-value calculating unit

11: power/current control unit

12: system voltage detector

13: power conversion system

14: step-up transformer

15: wind turbine control board

16: rotation speed detector

17: multiplier

18: rotation speed command computing device

19: PI controller

20: drive-train-vibration reducing controller

21: multiplier

22: system-voltage-returning-mode active-power-command-value computing unit

23: multiplier

24: active-power-command calculating unit

25: high-speed shaft brake

26: generator

27: rotor-side power converter

28: system-side power converter

29: secondary excitation type power conversion system

1. Wind power generating equipment comprising:
a generator that is driven by a blade which rotates by receiving the wind;
a power converter that converts an electric output of the generator such that the output is interconnected with an electric power system;
a power converter controller that controls the power converter; and
a wind turbine control board that transmits, to the power converter controller, an active power command value that is used as a command value of the electric output which is transmitted from the power converter,
wherein the power converter controller controls an electric output of the power converter in response to an active power command value depending on a reduction amount of a system voltage when instantaneous reduction occurs in the system voltage interconnected with the wind power generating equipment.

2. The wind power generating equipment according to claim 1,
wherein, in order to obtain an active power command value depending on the reduction amount of the system voltage, the power converter controller stores the active power command value transmitted from the wind turbine control board before the instantaneous reduction in the system voltage and performs computing by using the reduction amount of the system voltage and the stored value of the active power command value when reduction occurs in the system voltage.

3. The wind power generating equipment according to claim 1,
wherein the wind turbine control board transmits, to the power converter controller, the active power command value corresponding to a machine input from the generator at normal times and controls the electric output of the power converter via the power converter controller, and the active power command value contains a variation reducing component that reduces variations in a rotation speed of the generator.

4. The wind power generating equipment according to any one of claims 1,
wherein the wind turbine control board transmits, to the power converter controller, the active power command value that increases with the elapse of time when the system voltage returns after the instantaneous reduction in the system voltage interconnected with the wind power generating equipment and controls the electric output of the power converter via the power converter controller, and the active power command value contains a variation reducing component that reduces variations in a rotation speed of the generator.

5. An operation method of wind power generating equipment that includes a generator that is driven by a blade which rotates by receiving the wind and a power converter that converts an electric output of the generator such that the output is interconnected with an electric power system, the method comprising:
controlling an electric output of the power converter in response to an active power command value depending on a reduction amount of the system voltage when instantaneous reduction occurs in a system voltage interconnected with the wind power generating equipment.

6. The operation method of wind power generating equipment according to claim 5, further comprising:
controlling the electric output of the power converter by using the active power command value corresponding to a machine input from the generator when a system that is interconnected with the wind power generating equipment normally operates, the active power command value containing a variation reducing component that reduces variations in a rotation speed of the generator.

7. The operation method of wind power generating equipment according to claim 5, further comprising:
transmitting, to the power converter controller, the active power command value that increases with the elapse of time when the system voltage returns after the instantaneous reduction in the system voltage interconnected with the wind power generating equipment, the active power command value containing a variation reducing component that reduces variations in a rotation speed of the generator.

8. An operation method of wind power generating equipment that includes a generator that is driven by a blade which rotates by receiving the wind and a power converter that converts an electric output of the generator such that the output is interconnected with an electric power system, the method comprising:
controlling the power converter by using an active power command value that is transmitted as a command value of the electric output of the power converter and corresponds to a machine input from the generator during a normal operation, the active power command value containing a variation reducing component that reduces variations in a rotation speed of the generator;
controlling an electric output of the power converter in response to an active power command value depending on a reduction amount of a system voltage when instantaneous reduction occurs in the system voltage interconnected with the wind power generating equipment; and
transmitting, to the power converter controller, the active power command value that increases with the elapse of time when the system voltage returns after the instantaneous reduction in the system voltage interconnected with the wind power generating equipment, the active power command value containing a variation reducing component that reduces variations in a rotation speed of the generator.

9. A wind farm comprising:
a plurality of units of the wind power generating equipment according to claim 1;
a plurality of generators that are driven by a blade which rotates by receiving the wind;
and one or a plurality of power converters that convert an electric output of the generator such that the output is interconnected with an electric power system.

10. The wind power generating equipment according to claim 1,
wherein the power converter is configured to include a generator-side power converter that converts AC power of the generator as a synchronous generator into DC power, a DC capacitor, and a system-side power converter that converts DC power of the generator-side power converter into AC power.

11. The wind power generating equipment according to claim 1,
wherein the power converter is configured to include a rotor-side power converter that converts AC power of a rotor of the generator as a secondary excitation winding induction generator into DC power, a DC capacitor, and a system-side power converter that converts DC power of the rotor-side power converter into AC power.

12. The wind power generating equipment according to claim 2,
wherein the wind turbine control board transmits, to the power converter controller, the active power command value corresponding to a machine input from the generator at normal times and controls the electric output of the power converter via the power converter controller, and the active power command value contains a variation reducing component that reduces variations in a rotation speed of the generator.

13. The wind power generating equipment according to claim 3,
wherein the wind turbine control board transmits, to the power converter controller, the active power command value that increases with the elapse of time when the system voltage returns after the instantaneous reduction in the system voltage interconnected with the wind power generating equipment and controls the electric output of the power converter via the power converter controller, and the active power command value contains a variation reducing component that reduces variations in a rotation speed of the generator.

14. The wind power generating equipment according to claim 12,
wherein the wind turbine control board transmits, to the power converter controller, the active power command value that increases with the elapse of time when the system voltage returns after the instantaneous reduction in the system voltage interconnected with the wind power generating equipment and controls the electric output of the power converter via the power converter controller, and the active power command value contains a variation reducing component that reduces variations in a rotation speed of the generator.

15. The operation method of wind power generating equipment according to claim 6, further comprising:
Transmitting, to the power converter controller, the active power command value that increases with the elapse of time when the system voltage returns after the instantaneous reduction in the system voltage interconnected with the wind power generating equipment, the active power command value containing a variation reducing component that reduces variations in a rotation speed of the generator.

16. A wind farm comprising:
a plurality of units of the wind power generating equipment according to claims 2;
a plurality of generators that are driven by a blade which rotates by receiving the wind;
and one or a plurality of power converters that convert an electric output of the generator such that the output is interconnected with an electric power system.

17. A wind farm comprising:
a plurality of units of the wind power generating equipment according to claims 3;
a plurality of generators that are driven by a blade which rotates by receiving the wind;
and one or a plurality of power converters that convert an electric output of the generator such that the output is interconnected with an electric power system.

18. A wind farm comprising:
a plurality of units of the wind power generating equipment according to claims 4;
a plurality of generators that are driven by a blade which rotates by receiving the wind;
and one or a plurality of power converters that convert an electric output of the generator such that the output is interconnected with an electric power system.

19. The wind power generating equipment according to claim 2,
wherein the power converter is configured to include a generator-side power converter that converts AC power of the generator as a synchronous generator into DC power, a DC capacitor, and a system-side power converter that converts DC power of the generator-side power converter into AC power.

20. The wind power generating equipment according to claim 2,
wherein the power converter is configured to include a rotor-side power converter that converts AC power of a rotor of the generator as a secondary excitation winding induction generator into DC power, a DC capacitor, and a system-side power converter that converts DC power of the rotor-side power converter into AC power.
